(19) United States
(12) Patent Application Publication
(10) Pub. No.: US 2009/0158556 A1
(43) Pub. Date: Jun. 25, 2009

(54) COVERED ROTATION SHAFT STRUCTURE HAVING AUTO LOCKING FUNCTION

(76) Inventors: Jui-Hung Chang, Sinjhuang City (TW); Chun-Hung Hu, Sinjhuang City (TW)

Correspondence Address: Guice Patents PLLC, 12647 Galveston Court #302, Manassas, VA, 20112, US

(21) Appl. No.: 12/272,893

(22) Filed: Nov. 18, 2008

(30) Foreign Application Priority Data
Dec. 25, 2007 (TW) 096149855

(51) Int. Cl. E05D 11/10

(52) U.S. Cl. 16/330

(57) ABSTRACT

The present invention relates to a covered rotation shaft structure having auto locking function, includes: a cover member having a covering end, and one lateral side of the cover member is provided with a bump; a pivotal shaft having a first shaft section and a second shaft section, the first shaft section is pivotally provided on the covering end and the second shaft section is pivotally provided on a through hole of a retaining unit; a cam member composed by the above mentioned retaining unit and a rotating unit, the retaining unit has the above mentioned through hole and a concave slot, and the concave slot is served to mount the bump, so the retaining unit is retained on one side of the cover member, and the through hole is disposed adjacent to the covering end; and the rotating unit is provided on the second shaft section of the pivotal shaft and is provided against the retaining unit; at least one resilient member provided on the second shaft section of the pivotal shaft, and a screw nut is provided at the end of the second shaft section; when rotating the pivotal shaft, the rotating unit is released from a locking position, and the resilient member is pressed by the rotating unit, when reversely rotating the pivotal shaft, the rotating unit is moved toward the locking position and when the rotating unit is close to the locking position, the rotating unit is pushed to the locking position by the resilient member.

### BACKGROUND OF THE INVENTION

1. Field of the Invention

The present invention relates to a rotation shaft structure, more particularly to a covered rotation shaft structure having auto locking function.

2. Description of Related Art

Two objects serving as two members to perform relative rotation of opening/closing are commonly seen in daily life, e.g. a door sheet/set; by opening or closing two members, a goods with the two members can be defined as in an operation or in a non-operation status, e.g. a notebook computer, an electronic dictionary or a portable audio/video displayer.

A hinge is often adopted in a device capable of adjusting relative angles, as for the above mentioned notebook computer, the device adopted in the notebook computer is defined as a rotation shaft or a pivotal device, both of the rotation shaft and the pivotal device utilize theories of torque or friction, basically two interfering sets, e.g. friction members or cam members, are respectively provided on two members, and via the interference between the two interfering sets, an object of positioning in an opening or a closing status is therefore achieved.

As known in FIG. 1, which is one of the figures in the Taiwan Patent Application No. 096140002 filed by the present applicant on Nov. 13, 2007 and titled “rotation shaft structure having auto locking function”, the rotation shaft structure includes a cover member 10 having a covering end 101, one lateral side of the cover member 10 is provided with a bump 102; a concave slot 202 of a stopping unit 20 is served to let the bump 102 being buckled on, and the stopping unit 20 has a through hole 201; a pivotal shaft 30 having a first shaft section 301 and a second shaft section 302, the first shaft section 301 is pivotally provided on the covering end 101 and the second shaft section 302 is pivotally provided on the through hole 201 of the stopping unit 20; a locking and retaining unit 40 provided on the second shaft section 302 and fastened on the stopping unit 20; a locking and rotating unit 50 also provided on the second shaft section 302 and provided adjacently to the locking and retaining unit 40; plural resilient sheets 60 are provided on the second shaft section 302 and a screw nut 70 is provided at the end of the second shaft section 302 for retaining the resilient sheets 60. When rotating the rotation shaft 30, the locking and rotating unit 50 is released from a locking position and the resilient sheets 60 are pressed by the locking and rotating unit 50, when reversely rotating the pivotal shaft 30, the locking and rotating unit 50 is moved toward the locking position, and when the locking and retaining unit 50 is close to the locking position, the locking and rotating unit 50 is pushed to the locking position by the resilient sheets 60, so an object of auto locking is obtained. A pin 401 is axially extended from the locking and retaining unit 40 and is mounted in a pin hole 203 of the stopping unit 20, so the locking and retaining unit 40 is retained on one side of the stopping unit 20.

Though the described art has achieved functions of auto locking, easier in opening and harder in closing, and shock preventing, the locking and retaining unit 40 and the stopping unit 20 are individually and separately provided, thus production cost may be raised and assembly process may be complicated.

### SUMMARY OF THE INVENTION

The applicant of the present invention has devoted himself to design and commercially distribute rotation shafts, with a hope to overcome the disadvantages resulted from a locking and retaining unit and a stopping unit are separately provided to a conventional rotation shaft structure having auto locking function by integrating functions of auto locking and shock preventing provided on the locking and retaining unit and the stopping unit, after try and error, the present invention “Covered rotation shaft structure having auto locking function” is provided.

Features provided by the present invention are: a rotation shaft structure simultaneously has functions of auto locking, easier in opening and harder in closing and shock preventing and meanwhile has advantages of reducing units used, lowering production cost and simplifying assembly process.

For achieving the objects mentioned above, the present invention provides a covered rotation shaft structure having auto locking function, includes a cover member having a covering end, and one lateral side of the cover member is provided with a bump; a pivotal shaft having a first shaft section and a second shaft section, the first shaft section is pivotally provided on the covering end and the second shaft section is pivotally provided on a through hole of a retaining unit; a cam member composed by the above mentioned retaining unit and a rotating unit, the retaining unit has the above mentioned through hole and a concave slot, and the concave slot is served to mount the bump, so the retaining unit is retained on one side of the cover member, and the through hole is disposed adjacent to the covering end; and the rotating unit is provided on the second shaft section of the pivotal shaft and is provided against the retaining unit; plural resilient sheets provided on the second shaft section of the pivotal shaft, and a screw nut is provided at the end of the second shaft section; when rotating the pivotal shaft, the rotating unit is released from a locking position, and the resilient sheets are pressed by the rotating unit, when reversely rotating the pivotal shaft, the rotating unit is moved toward the locking position and when the rotating unit is close to the locking position, the rotating unit is pushed to the locking position by the resilient sheets.

Another solution provided by the present invention is to provide a covered rotation shaft structure having auto locking function, includes a cover member having a covering end, and one lateral side of the cover member is provided with a bump; a pivotal shaft having a first shaft section and a second shaft section, the first shaft section is pivotally provided on the covering end and the second shaft section is pivotally provided on a through hole of a retaining unit; a cam member composed by the above mentioned retaining unit and a rotating unit, the retaining unit has the above mentioned through hole and a concave slot, and the concave slot is served to mount the bump, so the retaining unit is retained on one side of the cover member, and the through hole is disposed adjacent to the covering end; and the rotating unit is provided on the second shaft section of the pivotal shaft and is provided against the retaining unit; a spring provided on the second shaft section of the pivotal shaft, and a screw nut is provided at the end of the second shaft section; when rotating the pivotal shaft, the rotating unit is released from a locking position, and the spring is pressed by the rotating unit, when reversely rotating the pivotal shaft, the rotating unit is moved toward the locking position and when the rotating unit is close to the locking position, the rotating unit is pushed to the locking position by the spring.

### BRIEF DESCRIPTION OF THE DRAWINGS

FIG. 1 is a 3D exploded view of a conventional rotation shaft structure having auto locking function;

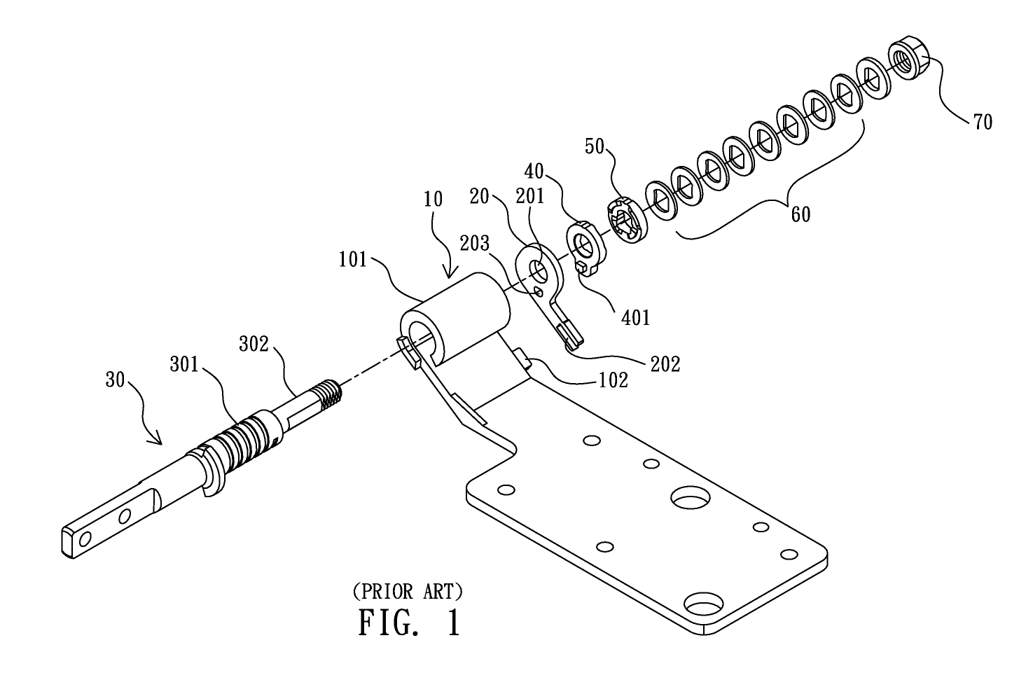

FIG. 2 is a 3D exploded view of the covered rotation shaft structure having auto locking function provided by the present invention;

FIG. 3 is a 3D exploded view of the covered rotation shaft structure having auto locking function provided by the present invention being viewed from another angle;

FIG. 4 is an assembly view of the covered rotation shaft structure having auto locking function provided by the present invention;

FIG. 5 is a 3D view of the retaining unit and rotating unit of the cam member provided by the present invention;

FIG. 6 is a 3D view illustrating the rotation shaft structure provided by the present invention being connected to a supporting rack and a retaining seat.

### DETAILED DESCRIPTION OF THE PREFERRED EMBODIMENT

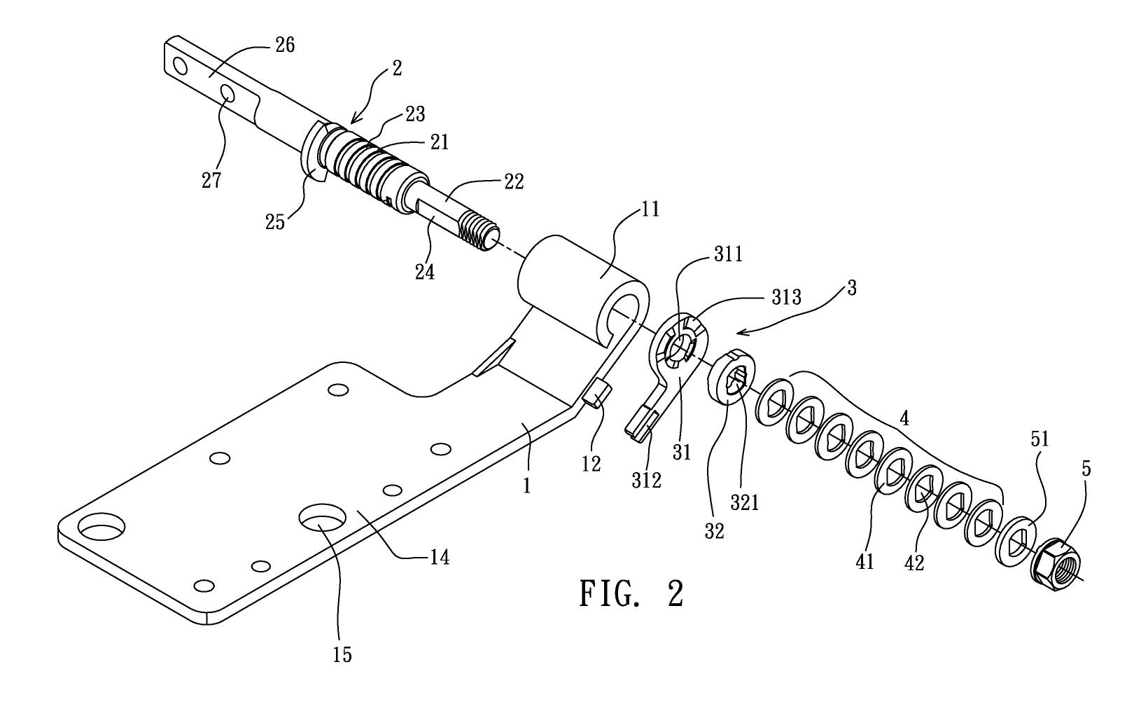

As shown from FIG. 2 to FIG. 4, the covered rotation shaft structure having auto locking function provided by the present invention is composed by a cover member 1, a pivotal shaft 2, a cam member 3, at least one resilient member 4 and a screw nut 5; wherein the cover member 1 and the pivotal shaft 2 can be further respectively connected to a supporting rack 6 and a retaining seat 7.

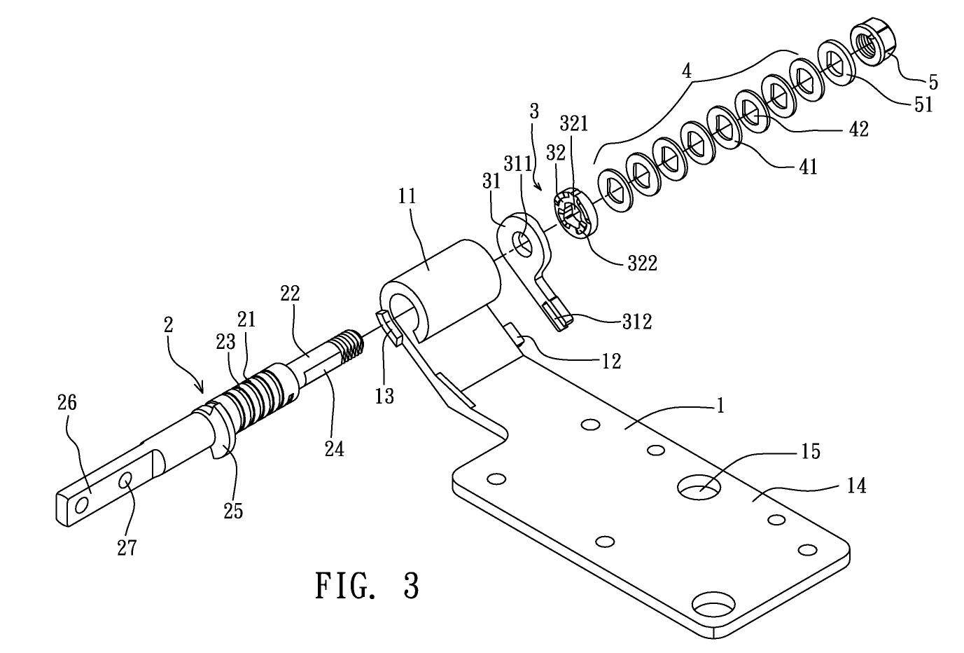

The cover member 1 is a rack member, one end thereof is defined as a covering end 11, one lateral side of the cover member 1 is provided with a bump 12 serving to let a retaining unit 31 of the cam member 3 being mounted and positioned. As shown in FIG. 3, the other lateral side of the cover member 1 is protrudingly provided with a stopping section 13 serving to limit the rotation angle of the pivotal shaft 2.

The pivotal shaft 2 is a stepped rod member, and has a first shaft section 21 and a second shaft section 22; as shown in FIG. 2 and FIG. 3, the outer diameter of the first shaft section 21 is larger than that of the second shaft section 22, and the first shaft section 21 is pivotally provided on the covering end 11 of the cover member 1, so a object of obtaining an effect of easier in opening and harder in closing is achieved; and the second shaft section 22 passes through a through hole 311 preset on the retaining unit 31 of the cam member 3, the diameter of the through hole 311 is with respect to the outer diameter of the second shaft section 22 so an object of shock preventing is achieved. To provide a lubrication effect between the first shaft section 21 and the covering end 11, the surface of the first shaft section 21 is provided with oil slots 23, e.g. screw-shaped oil slots. At least one plane 24 is axially provided on the surface of the second shaft section 22, after the plane 24 passes through the through hole 311, the plane 24 in sequence passes through a rotating unit 32 of the cam member 3 and the at least one resilient member 4, therefore a thread section of the second shaft section 22 is screwed with the screw nut 5; and via a lateral elastic force provided by the resilient member 4, a contact status between the rotating unit 32 and the retaining unit 31 provided adjacent to the rotating unit 32 is obtained. A positioning section 25 can be further provided on the first shaft section 21 of the pivotal shaft 2, when rotating the pivotal shaft 2, the positioning section 25 of the pivotal shaft 2 can be stopped by the stopping section 13 of the cover member 1 so the rotation angle of the pivotal shaft 2 is limited.

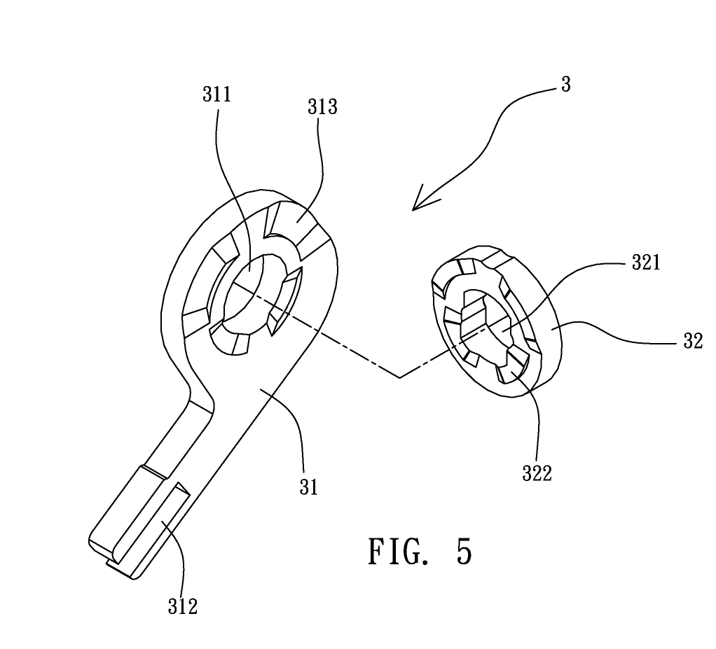

Referring to FIG. 2, FIG. 3 and FIG. 5, the cam member 3 is composed by the above mentioned retaining unit 31 and the above mentioned rotating unit 32. The above mentioned through hole 311 is axially provided on the retaining unit 31 to let the second shaft section 22 pass through. For retaining the retaining unit 31 on one side of the covering end 11, a concave slot 312 is axially provided on the retaining unit 31 with respect to the location where the bump 12 is provided, via the concave slot 312 being mounted in the bump 12 the retaining unit 31 is retained on one side of the covering end 11, and the through hole 311 is disposed adjacent to the covering end 11.

A retaining hole 321 mating with the cross surface of the second shaft section 22 is provided on the rotating unit 32 so as to obtain a link. As shown in FIG. 5, the retaining unit 31 has a positioning slot 313, and a positioning block 322 is provided on the rotating unit 32 with respect to the positioning slot 313, when in a locking status, the positioning block 322 is received in the positioning slot 313; in another embodiment of the present invention, the retaining unit 31 has a positioning block and the rotating unit 32 has a positioning slot.

As shown in FIG. 2 and FIG. 3, the resilient member 4 is composed by plural resilient sheets 41 having arc-shaped surfaces, the plural resilient sheets 41 are provided on the second shaft section 22 with a fashion that a convex surface of one of the resilient sheets 41 faces a convex surface of another one of the resilient sheets 41. The resilient member 4 can be a spring, instead of resilient sheets 41. The resilient sheets 41 are linked with the second shaft section 22 of the pivotal shaft 2, so a shape of a retaining hole 42 respectively provided on each of the resilient sheets 41 is mated with the cross surface of the second shaft section 22 having at least one plane 24. A pad 51 is provided between the resilient member 4 and the screw nut 5 to prevent the screw nut 5 from being released.

When rotating the pivotal shaft 2, the rotating unit 32 is released from the locking position, and the plural resilient sheets 41 or the spring is pressed by the rotating unit 32, when reversely rotating the pivotal shaft 2, the rotating unit 32 is moved toward the locking position and when the rotating unit 32 is close to the locking position, the rotating unit 32 is pushed to the locking position by the plural resilient sheets 41 or the spring, so an object of auto locking is therefore achieved.

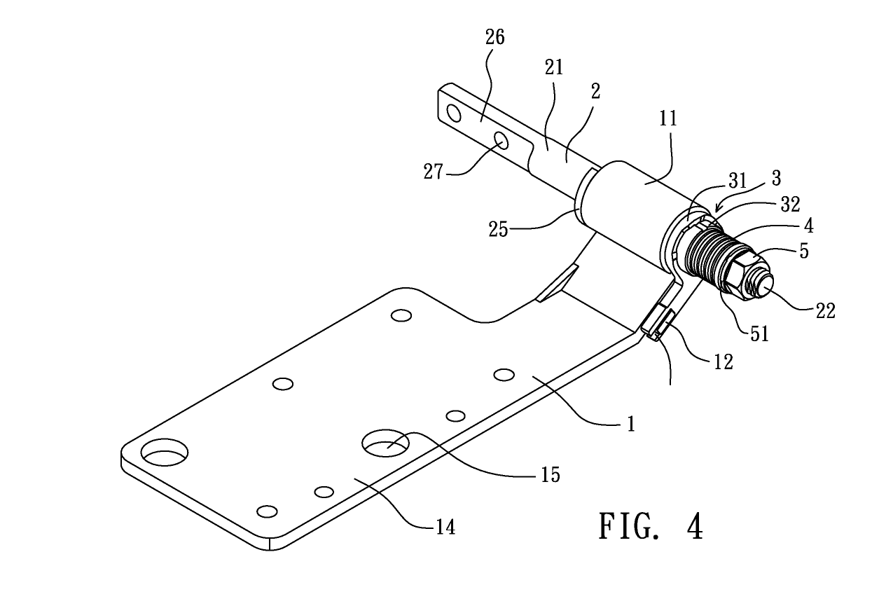

FIG. 4 illustrates the assembly of the present invention, wherein the first shaft section 21 of the pivotal shaft 2 is pivotally provided on the covering end 11 of the cover member 1, the second shaft section 22 is pivotally provided on the through hole 311 of the retaining unit 31 then is in sequence provided with the rotating unit 32, the at least one resilient member 4 and the screw nut 5.

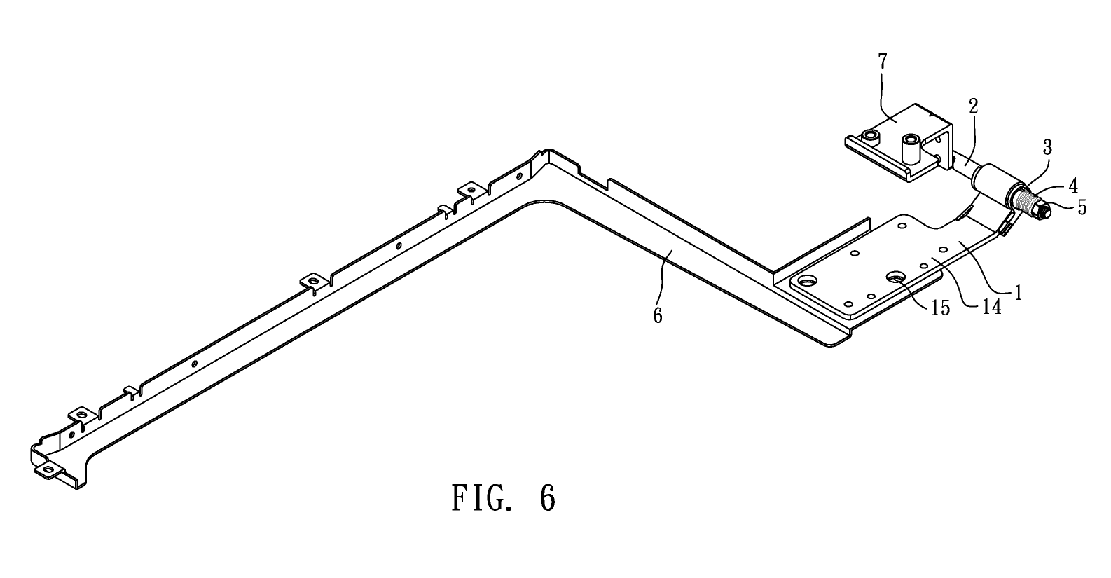

Referring to FIG. 6, for respectively connecting the cover member 1 and the pivotal shaft 2 to a cover section and a main body section of an object such as a notebook computer, an extending section 14 is provided on the cover member 1, and the surface thereof has plural positioning holes 15 for being connected to a supporting rack 6 of the cover section; the other end of the pivotal shaft 2, defined as a connecting end 26, is provided with plural connecting holes 27 for being connected to a retaining seat 7 of the main body section.

The features of the present invention are following: the first shaft section of the pivotal shaft is pivotally connected to the covering end of the cover member, so an object of easier in opening and harder in closing is achieved; a bump is provided at one side of the cover member so a concave slot axially extended from the retaining unit can be mounted therein, and a through hole axially provided on the retaining unit is served to let the second shaft section pass through therefore an object of shock preventing is achieved; the second shaft section of the pivotal shaft is pivotally connected to a retaining unit then is connected to a rotating unit, and is provided with plural resilient sheets or a spring and a screw nut is served to fastened the resilient sheets or the spring, when rotating the pivotal shaft, the rotating unit is released from a locking position and the plural resilient sheets or the spring are pressed by the rotating unit, and when reversely rotating the pivotal shaft, the rotating unit is moved toward the locking position and when the rotating unit is close to the locking position, the rotating unit is pushed to the locking position by the resilient sheets or the spring, so an object of auto locking is achieved. Moreover, the retaining unit provided by the present invention has functions of shock preventing and auto locking, and has advantages of reducing units used, lowering production cost, and simplifying assembly process.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A covered rotation shaft structure having auto locking function, includes
a cover member having a covering end, and one lateral side of the cover member is provided with a bump;
a pivotal shaft having a first shaft section and a second shaft section, the first shaft section is pivotally provided on the covering end and the second shaft section is pivotally provided on a through hole of a retaining unit;
a cam member composed by the retaining unit and a rotating unit, the retaining unit has the through hole and a concave slot, and the concave slot is served to mount the bump, so the retaining unit is retained on one side of the cover member, and the through hole is disposed adjacent to the covering end, and the rotating unit is provided on the second shaft section of the pivotal shaft and is provided against the retaining unit;
plural resilient sheets provided on the second shaft section of the pivotal shaft, and a screw nut is provided at the end of the second shaft section;
when rotating the pivotal shaft, the rotating unit is released from a locking position, and the resilient sheets are pressed by the rotating unit, when reversely rotating the pivotal shaft, the rotating unit is moved toward the locking position and when the rotating unit is close to the locking position, the rotating unit is pushed to the locking position by the resilient sheets.

2. The covered rotation shaft structure having locking function as claimed in claim 1, wherein the retaining unit has a positioning slot and the rotating unit has a positioning block, when in the locking position, the positioning block is received in the positioning slot.

3. The covered rotation shaft structure having locking function as claimed in claim 1, wherein the retaining unit has a positioning block and the rotating unit has a positioning slot, when in the locking position, the positioning block is received in the positioning slot.

4. The covered rotation shaft structure having locking function as claimed in claim 1, wherein the other end of the cover member is provided with a stopping section, and the first shaft section of the pivotal shaft is provided with a positioning section, when rotating the pivotal shaft, the positioning section of the pivotal shaft is stopped by the stopping section of the cover member so the rotation angle of the pivotal shaft is limited.

5. The covered rotation shaft structure having locking function as claimed in claim 1, wherein the first shaft section of the pivotal shaft is provided with oil slots, and a pad is provided between the screw nut and the plural resilient sheets.

6. The covered rotation shaft structure having locking function as claimed in claim 1, wherein the second shaft section of the pivotal shaft is provided with at least one plane, a retaining hole is provided on the rotating unit and a retaining hole is respectively provided on each of the plural resilient sheets with respect to the retaining hole of the rotating unit so as to provide the rotating unit and the plural resilient sheets on the second shaft section.

7. The covered rotation shaft structure having locking function as claimed in claim 1, wherein the plural resilient sheets having arc-shaped surfaces, the plural resilient sheets are provided on the rear end of the second shaft section with a fashion that a convex surface of one of the resilient sheets faces a convex surface of another one of the resilient sheets.

8. The covered rotation shaft structure having locking function as claimed in claim 1, wherein the cover member has an extending end and a positioning hole is provided on the extending end for being connected to a supporting rack; the pivotal shaft has a connecting end, a connecting hole is provided on the connecting end for being connected to a retaining seat.

9. A covered rotation shaft structure having locking function, includes:
a cover member having a covering end, and one lateral side of the cover member is provided with a bump;
a pivotal shaft having a first shaft section and a second shaft section, the first shaft section is pivotally provided on the covering end and the second shaft section is pivotally provided on a through hole of a retaining unit;
a cam member composed by the retaining unit and a rotating unit, the retaining unit has the through hole and a concave slot, and the concave slot is served to mount the bump, so the retaining unit is retained on one side of the cover member, and the through hole is disposed adjacent to the covering end, and the rotating unit is provided on the second shaft section of the pivotal shaft and is provided against the retaining unit;
a spring provided on the second shaft section of the pivotal shaft, and a screw nut is provided at the end of the second shaft section;
when rotating the pivotal shaft, the rotating unit is released from a locking position, and the spring is pressed by the rotating unit, when reversely rotating the pivotal shaft, the rotating unit is moved toward the locking position and when the rotating unit is close to the locking position, the rotating unit is pushed to the locking position by the spring.

10. The covered rotation shaft structure having locking function as claimed in claim 9, wherein the retaining unit has a positioning slot and the rotating unit has a positioning block, when in the locking position, the positioning block is received in the positioning slot.

11. The covered rotation shaft structure having locking function as claimed in claim 9, wherein the retaining unit has a positioning block and the rotating unit has a positioning slot, when in the locking position, the positioning block is received in the positioning slot.

12. The covered rotation shaft structure having locking function as claimed in claim 9, wherein the other end of the cover member is provided with a stopping section, and the first shaft section of the pivotal shaft is provided with a positioning section, when rotating the pivotal shaft, the positioning section of the pivotal shaft is stopped by the stopping section of the cover member so the rotation angle of the pivotal shaft is limited.

13. The covered rotation shaft structure having locking function as claimed in claim 9, wherein the first shaft section of the pivotal shaft is provided with oil slots, and a pad is provided between the screw nut and the plural resilient sheets.

14. The covered rotation shaft structure having locking function as claimed in claim 9, wherein the cover member has an extending end and a positioning hole is provided on the extending end for being connected to a supporting rack; the pivotal shaft has a connecting end, a connecting hole is provided on the connecting end for being connected to a retaining seat.
